(19) United States
(12) Patent Application Publication
(10) Pub. No.: US 2025/0076332 A1
(43) Pub. Date: Mar. 6, 2025

(54) AUTOMATIC ANALYZING APPARATUS AND METHOD

(71) Applicant: Canon Medical Systems Corporation, Otawara-shi (JP)

(72) Inventors: Gaku UENO, Sakura (JP); Yoshihiro JIFUKU, Nasushiobara (JP); Tamaki HONDA, Nasushiobara (JP); Shohei KAWASHIMA, Nasushiobara (JP); Masakazu KITAMURA, Nasushiobara (JP)

(73) Assignee: Canon Medical Systems Corporation, Otawara-shi (JP)

(21) Appl. No.: 18/822,561

(22) Filed: Sep. 3, 2024

(30) Foreign Application Priority Data
Sep. 4, 2023 (JP) 2023-143029

(51) Int. Cl. G01N 35/10

(52) U.S. Cl. CPC G01N 35/1004; G01N 35/1002

(57) ABSTRACT

According to one embodiment, an automatic analyzing apparatus includes memory and processing circuitry. The memory stores attribute information indicating an attribute regarding cleaning set for any of a plurality of reagents. The processing circuitry performs at least one of rearrangement of a measurement order of a plurality of examination items in an examination and determination of necessity of probe cleaning by a detergent in the examination based on the attribute information.

### CROSS-REFERENCE TO RELATED APPLICATION

This application is based upon and claims the benefit of priority from Japanese Patent Application No. 2023-143029, filed Sep. 4, 2023, the entire contents of which are incorporated herein by reference.

### FIELD

Embodiments described herein relate generally to an automatic analyzing apparatus and a method.

### BACKGROUND

In an automatic analyzing apparatus, in a case where a plurality of examination items is examined, components of a reagent used in measurement of a previous examination item may influence measurement of a subsequent examination item. This is called reagent contamination. In order to avoid this reagent contamination, the automatic analyzing apparatus has a function of registering a reagent that is influenced with respect to examination items in advance and changing an order of measurements based on information of the registered reagent, and a function of cleaning a reagent dispensing probe with a detergent.

However, with diversification of examination items, reagent contamination may not be avoided even if the order of measurements is changed. Alternatively, the order of measurements may not be able to be changed. In such a case, since it is necessary to clean the reagent dispensing probe with a detergent, a cycle for cleaning occurs, and there is a concern about a decrease in throughput of the examination.

### BRIEF DESCRIPTION OF DRAWINGS

FIG. 1 is a block diagram illustrating an example of an automatic analyzing apparatus according to a first embodiment.

FIG. 2 is a diagram illustrating a configuration example of an analysis mechanism of FIG. 1.

FIG. 3 is a flowchart illustrating an operation example of reagent contamination avoidance processing in the first embodiment.

FIG. 4 is a diagram illustrating a display example of a reagent registration window in the first embodiment.

FIG. 5 is a diagram illustrating an example of registered reagent information in the first embodiment.

FIG. 6 is a diagram illustrating a display example of an examination item registration window (basic settings) in the first embodiment.

FIG. 7 is a diagram illustrating a display example of an examination item registration window (carry-over settings) in the first embodiment.

FIG. 8 is a diagram illustrating an example of registered examination item information in the first embodiment.

FIG. 9 is a diagram illustrating an execution result of the reagent contamination avoidance processing in the first embodiment.

FIG. 10 is a diagram illustrating an execution result of the reagent contamination avoidance processing in a modification of the first embodiment.

FIG. 11 is a flowchart illustrating an operation example of a reagent contamination avoidance processing in a second embodiment.

FIG. 12 is a diagram illustrating a display example of a reagent registration window in the second embodiment.

FIG. 13 is a diagram illustrating an example of registered reagent information in the second embodiment.

FIG. 14 is a diagram illustrating a display example of an examination item registration window (basic settings) in the second embodiment.

FIG. 15 is a diagram illustrating a display example of an examination item registration window (carry-over settings) in the second embodiment.

FIG. 16 is a diagram illustrating an example of registered examination item information in the second embodiment.

FIG. 17 is a diagram illustrating an execution result of the reagent contamination avoidance processing in the second embodiment.

### DETAILED DESCRIPTION

In general, according to one embodiment, an automatic analyzing apparatus includes memory and processing circuitry. The memory stores attribute information indicating an attribute regarding cleaning set for any of a plurality of reagents. The processing circuitry performs at least one of rearrangement of a measurement order of a plurality of examination items in an examination and determination of necessity of probe cleaning by a detergent in the examination based on the attribute information.

Hereinafter, embodiments of an automatic analyzing apparatus will be described in detail with reference to the drawings.

### First Embodiment

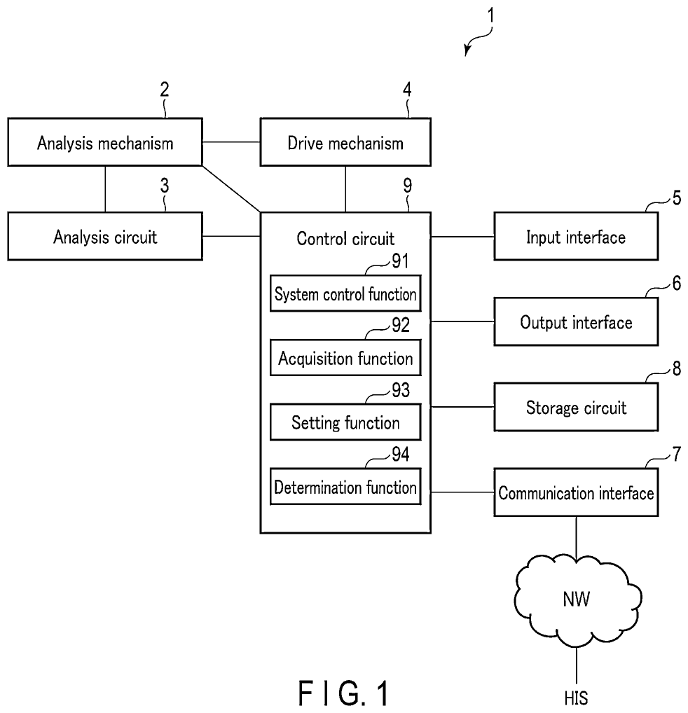

FIG. 1 is a block diagram illustrating an example of an automatic analyzing apparatus according to a first embodiment. An automatic analyzing apparatus 1 illustrated in FIG. 1 includes an analysis mechanism 2, an analysis circuit 3, a drive mechanism 4, an input interface 5, an output interface 6, a communication interface 7, a storage circuit 8 (storage unit), and a control circuit 9 (control unit). The automatic analyzing apparatus 1 measures the components in a specimen by measuring a mixed liquid of the specimen to be measured and a sample.

The analysis mechanism 2 mixes a sample such as a standard sample or a sample to be examined (also referred to as a specimen) with a reagent used for each examination item set for this sample. The analysis mechanism 2 measures a mixed liquid of a sample and a reagent, and generates standard data and examination data that are represented by, for example, absorbance.

The analysis circuit 3 is a processor that generates calibration data, analysis data, and the like by analyzing the standard data and the examination data generated by the analysis mechanism 2. The analysis circuit 3 reads an analysis program from the storage circuit 8, and generates calibration data, analysis data, and the like according to the read analysis program. For example, the analysis circuit 3 generates calibration data indicating a relationship between the standard data and a standard value set in advance for the standard sample based on the standard data. Further, the analysis circuit 3 generates analysis data expressed as a concentration value and an enzyme activity value based on the examination data and the calibration data of the examination item corresponding to this examination data. The analysis circuit 3 outputs the generated calibration data, analysis data, and the like to the control circuit 9.

The drive mechanism 4 drives the analysis mechanism 2 under the control of the control circuit 9. The drive mechanism 4 is realized by, for example, a gear, a stepping motor, a belt conveyor, a lead screw, and the like.

The input interface 5 receives, for example, settings such as analysis parameters for each examination item related to the sample requested to be measured from an operator or via an in-hospital network NW. The input interface 5 is realized by, for example, a mouse, a keyboard, a touch pad to which an instruction is input by touching an operation surface, and the like. The input interface 5 is connected to the control circuit 9, converts an operation instruction input from the operator into an electric signal, and outputs the electric signal to the control circuit 9.

Note that, in the present specification, the input interface 5 is not limited to those including physical operation components such as a mouse, a keyboard, and a touch pad. For example, an electric signal processing circuit that receives an electric signal corresponding to an operation instruction input from an external input device provided separately from the automatic analyzing apparatus 1 and outputs this electric signal to the control circuit 9 is also included in the example of the input interface 5.

The output interface 6 is connected to the control circuit 9 and outputs a signal supplied from the control circuit 9. The output interface 6 is realized by, for example, a display circuit, a printed circuit, an audio device, and the like. The display circuit includes, for example, a CRT display, a liquid crystal display, an organic EL display, an LED display, a plasma display, and the like. Further, the display circuit may include a processing circuit that converts data representing an object to be displayed into a video signal and outputs the video signal to the outside. The printed circuit includes, for example, a printer. Further, the print circuit may include an output circuit that outputs data representing an object to be printed to the outside. The audio device includes, for example, a speaker. Further, the audio device may include an output circuit that outputs an audio signal to the outside.

The communication interface 7 is connected to, for example, the in-hospital network NW. The communication interface 7 performs data communication with a hospital information system (HIS) via the in-hospital network NW. Note that, the communication interface 7 may perform data communication with the HIS via a laboratory information system (LIS) connected to the in-hospital network NW.

The storage circuit 8 includes a recording medium readable by a processor, such as a magnetic recording medium, an optical recording medium, or a semiconductor memory. Note that, the storage circuit 8 is not necessarily realized by a single storage device. For example, the storage circuit 8 may be realized by a plurality of storage devices.

Further, the storage circuit 8 stores an analysis program executed by the analysis circuit 3 and a control program for implementing a function included in the control circuit 9. The storage circuit 8 stores the analysis data generated by the analysis circuit 3 for each examination item. The storage circuit 8 stores an examination order input from the operator or an examination order received by the communication interface 7 via the in-hospital network NW.

Further, the storage circuit 8 stores reagent information related to a reagent. The reagent information includes, for example, information such as a reagent name, a type, and an attribute, which are associated with each other. The reagent information is not limited to a reagent, and may be any liquid other than a sample loaded on the automatic analyzing apparatus 1.

The information on the type (type information) is, for example, the type of liquid other than the sample loaded on the automatic analyzing apparatus 1. Specifically, the type information includes, for example, a first reagent (R1), a second reagent (R2), a carry-over avoidance detergent, an acidic detergent, an alkaline detergent, a diluent, and a thermostatic bath additive.

The information on the attribute (attribute information) indicates properties related to cleaning. Specifically, the attribute information is physical property information indicating physical properties related to hydrogen ions contained in the reagent. The attribute information includes, for example, a neutral reagent, an alkaline reagent, and an acidic reagent. A detailed role of the attribute information will be described later. Note that, the attribute information may be set only for some reagents.

Further, the storage circuit 8 stores examination item information related to the examination item. The examination item information is set for each of the plurality of examination items. The examination item information includes, for example, basic setting information, carry-over setting information, and the like, which are associated with each other.

The basic setting information includes, for example, information such as absorbance, a sample, a diluent, a reagent, and a stirrer for the examination item, which are associated with each other. The information on the reagent of the examination item (examination item reagent information) includes, for example, information on the reagent names of the first reagent and the second reagent, a reagent amount of each reagent, and an amount of water for dilution. The reagent name here usually includes the reagent stored in the above-described reagent information.

The carry-over setting information includes, for example, information such as reagent carry-over avoidance cleaning for the examination item. The information on reagent carry-over avoidance cleaning includes information such as a reagent name that influences the examination item (an influence reagent name), a cleaning method, an amount of a detergent, the number of times of cleaning, and reagent cleaning permission, which are associated with each other. In a case where a reagent (for example, an alkaline reagent) having attribute information is set in the item of the cleaning method, the information on reagent cleaning permission (reagent cleaning permission information) indicates whether or not this reagent is used for cleaning. Note that, reagent cleaning is to perform an examination of an examination item using a reagent that is expected to have a cleaning effect, and is not intended to perform only cleaning in one cycle as in detergent cleaning.

Further, the storage circuit 8 stores information on the sample to be analyzed by the automatic analyzing apparatus 1. Specifically, the storage circuit 8 stores information on the sample to be examined (examination target sample information) based on a sample container loaded in the automatic analyzing apparatus 1. The examination target sample information includes an ID for specifying the sample requested to be measured. Further, the storage circuit 8 stores information on one or more examination items associated with the sample to be examined. Further, the storage circuit 8 stores information on the order of samples to be analyzed by the automatic analyzing apparatus 1 (sample order information).

The control circuit 9 is a processor that functions as a center of the automatic analyzing apparatus 1. The control circuit 9 implements a function corresponding to the executed control program by executing the control program stored in the storage circuit 8. A function of the control circuit 9 according to the first embodiment will be described later. Note that, the control circuit 9 may include a storage area for storing at least a part of the data stored in the storage circuit 8.

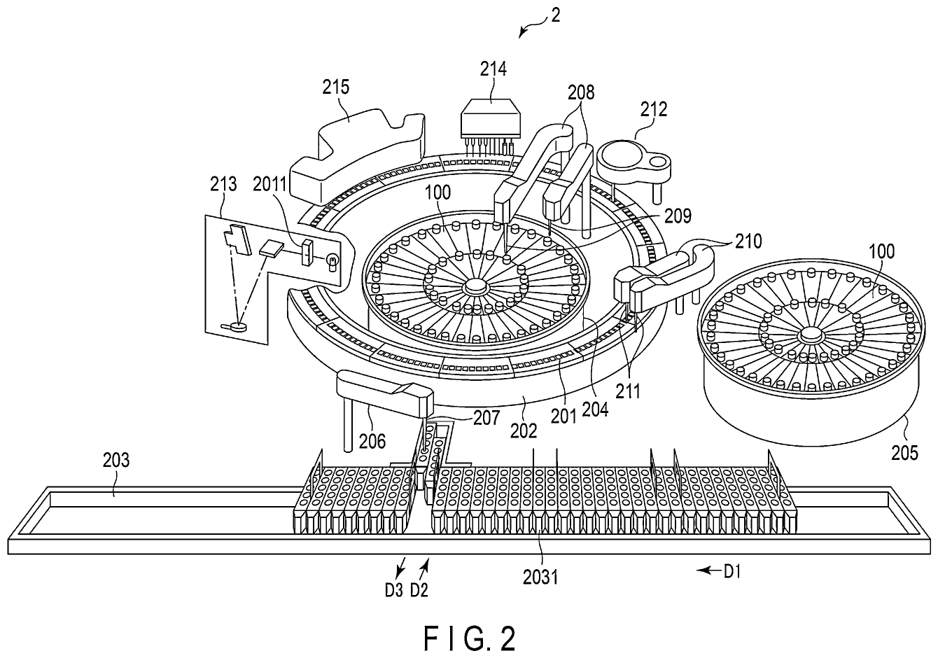

FIG. 2 is a diagram illustrating a configuration of an analysis mechanism illustrated in FIG. 1. The analysis mechanism 2 illustrated in FIG. 2 includes a reaction disk 201, a thermostatic unit 202, a rack sampler 203, a first reagent storage 204, and a second reagent storage 205. Further, the analysis mechanism 2 includes a sample dispensing arm 206, a sample dispensing probe 207, a first reagent dispensing arm 208, a first reagent dispensing probe 209, a second reagent dispensing arm 210, a second reagent dispensing probe 211, an electrode unit 212, a photometric unit 213, a cleaning unit 214, and a stirring unit 215.

Hereinafter, first, the reaction disk 201, the thermostatic unit 202, the rack sampler 203, the first reagent storage 204, and the second reagent storage 205 will be described.

The reaction disk 201 holds a plurality of reaction containers 2011 arranged in a ring shape. The reaction disk 201 conveys the plurality of reaction containers 2011 along a predetermined path. Specifically, the reaction disk 201 is alternately rotated and stopped at a predetermined time interval (hereinafter, referred to as one cycle), for example, 4.5 seconds or 9.0 seconds by the drive mechanism 4. The reaction container 2011 is formed of, for example, glass, polypropylene (PP), or acrylic.

The thermostatic unit 202 stores a heating medium set at a predetermined temperature, and immerses the reaction container 2011 in the stored heating medium to raise a temperature of the mixed liquid contained in the reaction container 2011.

The rack sampler 203 movably supports a sample rack 2031 capable of holding a plurality of sample containers that contains the sample requested to be measured. In the example illustrated in FIG. 2, a sample rack 2031 capable of holding five sample containers in parallel is illustrated.

The rack sampler 203 is provided with a conveyance region for conveying the sample rack 2031 from a loading position where the sample rack 2031 is loaded to a collection position where the sample rack 2031 for which measurement has been completed is collected. In the conveyance region, a plurality of sample racks 2031 aligned in a lateral direction is moved in a direction D1 by the drive mechanism 4.

Further, in order to move the sample container held by the sample rack 2031 to a predetermined sample suction position, the rack sampler 203 is provided with a drawing region in which the sample rack 2031 is drawn from the conveyance region. The sample suction position is provided, for example, at a position where a rotation trajectory of the sample dispensing probe 207 intersects with a movement trajectory of an opening of the sample container that is supported by the rack sampler 203 and held by the sample rack 2031. In the drawing region, the sample rack 2031 that has been conveyed is moved in a direction D2 by the drive mechanism 4.

Further, the rack sampler 203 is provided with a return region for returning the sample rack 2031 holding the sample container in which the sample is sucked to the conveyance region. In the return region, the sample rack 2031 is moved in a direction D3 by the drive mechanism 4.

Note that, the rack sampler 203 may be provided with a barcode reader for reading a barcode attached to the sample container. The barcode reader is provided, for example, near the loading position of the rack sampler 203, and reads a barcode attached to the sample container held by the sample rack 2031.

The first reagent storage 204 cools a plurality of reagent containers 100 that contains a first reagent that reacts with a predetermined component contained in a standard sample and a sample to be examined. Although not illustrated in FIG. 2, the first reagent storage 204 is covered with a detachable reagent cover. In the first reagent storage 204, a reagent rack is provided in a rotatable manner. The reagent rack holds a plurality of reagent containers 100 arranged in an annular shape. The reagent rack is rotated by the drive mechanism 4.

A first reagent suction position is set at a predetermined position on the first reagent storage 204. The first reagent suction position is provided, for example, at a position where the rotation trajectory of the first reagent dispensing probe 209 intersects with the movement trajectory of the opening of the reagent container 100 arranged in an annular shape on the reagent rack.

The second reagent storage 205 cools a plurality of reagent containers 100 that contains a second reagent paired with a first reagent of a two-reagent system. Although not illustrated in FIG. 2, the second reagent storage 205 is covered with a detachable reagent cover. In the second reagent storage 205, a reagent rack is provided in a rotatable manner. The reagent rack holds a plurality of reagent containers 100 arranged in an annular shape.

A second reagent suction position is set at a predetermined position on the second reagent storage 205. The second reagent suction position is provided, for example, at a position where the rotation trajectory of the second reagent dispensing probe 211 to be described later intersects with the movement trajectory of the opening of the reagent container 100 arranged in an annular shape on the reagent rack.

Next, the sample dispensing arm 206, the sample dispensing probe 207, the first reagent dispensing arm 208, the first reagent dispensing probe 209, the second reagent dispensing arm 210, the second reagent dispensing probe 211, the electrode unit 212, the photometric unit 213, the cleaning unit 214, and the stirring unit 215 will be described.

The sample dispensing arm 206 is provided between the reaction disk 201 and the rack sampler 203. The sample dispensing arm 206 is provided to be movable up and down in a vertical direction and to be rotatable in a horizontal direction by the drive mechanism 4. The sample dispensing arm 206 holds the sample dispensing probe 207 at one end.

The sample dispensing probe 207 rotates along an arc-shaped rotation trajectory along with rotation of the sample dispensing arm 206. An opening of the sample container held by the sample rack 2031 on the rack sampler 203 is located on this rotation trajectory.

Further, a sample discharge position for discharging the sample sucked by the sample dispensing probe 207 to the reaction container 2011 is provided on the rotation trajectory of the sample dispensing probe 207. The sample discharge position corresponds to an intersection point between the rotation trajectory of the sample dispensing probe 207 and the movement trajectory of the reaction container 2011 held on the reaction disk 201.

Further, the sample dispensing probe 207 is driven by the drive mechanism 4 and moves in the vertical direction directly above the opening of the sample container held by the sample rack 2031 on the rack sampler 203 or at the sample discharge position.

Further, under the control of the control circuit 9, the sample dispensing probe 207 sucks a sample from the sample container located directly below. Further, under the control of the control circuit 9, the sample dispensing probe 207 discharges the sucked sample to the reaction container 2011 located directly below the sample discharge position. The sample dispensing probe 207 performs a series of dispensing operations of suction and discharge, for example, once during one cycle.

The first reagent dispensing arm 208 is provided, for example, between the reaction disk 201 and the first reagent storage 204. The first reagent dispensing arm 208 is provided to be movable up and down in the vertical direction and to be rotatable in the horizontal direction by the drive mechanism 4. The first reagent dispensing arm 208 holds the first reagent dispensing probe 209 at one end.

The first reagent dispensing probe 209 rotates along an arc-shaped rotation trajectory along with the rotation of the first reagent dispensing arm 208. The first reagent suction position is provided on this rotation trajectory. Further, a first reagent discharge position for discharging the reagent sucked by the first reagent dispensing probe 209 to the reaction container 2011 is set on the rotation trajectory of the first reagent dispensing probe 209. The first reagent discharge position corresponds to an intersection point between the rotation trajectory of the first reagent dispensing probe 209 and the movement trajectory of the reaction container 2011 held on the reaction disk 201.

The first reagent dispensing probe 209 is driven by the drive mechanism 4 and moves in the vertical direction at the first reagent suction position on the rotation trajectory or at the first reagent discharge position. Further, the first reagent dispensing probe 209 sucks the first reagent from the reagent container located directly below the first reagent suction position under the control of the control circuit 9. Further, the first reagent dispensing probe 209 discharges the sucked first reagent to the reaction container 2011 located directly below the first reagent discharge position under the control of the control circuit 9.

The second reagent dispensing arm 210 is provided, for example, between the reaction disk 201 and the second reagent storage 205. The second reagent dispensing arm 210 is provided to be movable up and down in the vertical direction and to be rotatable in the horizontal direction by the drive mechanism 4. The second reagent dispensing arm 210 holds the second reagent dispensing probe 211 at one end.

The second reagent dispensing probe 211 rotates along an arc-shaped rotation trajectory along with the rotation of the second reagent dispensing arm 210. The second reagent suction position is provided on this rotation trajectory. Further, a second reagent discharge position for discharging the reagent sucked by the second reagent dispensing probe 211 to the reaction container 2011 is set on the rotation trajectory of the second reagent dispensing probe 211. The second reagent discharge position corresponds to an intersection point between the rotation trajectory of the second reagent dispensing probe 211 and the movement trajectory of the reaction container 2011 held on the reaction disk 201.

The second reagent dispensing probe 211 is driven by the drive mechanism 4 and moves in the vertical direction at the second reagent suction position on the rotation trajectory or at the second reagent discharge position. Further, the second reagent dispensing probe 211 sucks the second reagent from the reagent container located directly below the second reagent suction position under the control of the control circuit 9. Further, the second reagent dispensing probe 211 discharges the sucked second reagent to the reaction container 2011 located directly below the second reagent discharge position under the control of the control circuit 9.

The electrode unit 212 measures an electrolyte concentration of the mixed liquid of the sample and the reagent discharged into the reaction container 2011. The electrode unit 212 has an ion selective electrode (ISE) and a reference electrode. Under the control of the control circuit 9, the electrode unit 212 measures a potential between the ISE and the reference electrode for the mixed liquid containing the ions to be measured. The electrode unit 212 outputs data obtained by measuring the potential to the analysis circuit 3 as standard data or examination data.

The photometric unit 213 optically measures a predetermined component in the mixed liquid of the sample and the reagent discharged into the reaction container 2011. The photometric unit 213 includes a light source and a photodetector. The photometric unit 213 emits light from the light source under the control of the control circuit 9. The irradiated light is incident from a first side wall of the reaction container 2011 and emitted from a second side wall facing the first side wall. The photometric unit 213 detects the light emitted from the reaction container 2011 by a photodetector.

Specifically, for example, the photodetector detects light that has passed through a mixed liquid of the standard sample and the reagent in the reaction container 2011, and generates standard data represented by absorbance or the like based on intensity of the detected light. Further, the photodetector detects light that has passed through a mixed liquid of the sample to be examined and the reagent in the reaction container 2011, and generates examination data represented by absorbance or the like based on the intensity of the detected light. The photometric unit 213 outputs the generated standard data and examination data to the analysis circuit 3.

The cleaning unit 214 cleans the inside of the reaction container 2011 in which the measurement of the mixed liquid has been completed in the electrode unit 212 or the photometric unit 213. This cleaning unit 214 includes a cleaning liquid supply pump (not illustrated) that supplies a cleaning liquid for cleaning the reaction container 2011. Further, the cleaning unit 214 includes a cleaning nozzle that discharges the cleaning liquid supplied from the cleaning liquid supply pump into the reaction container 2011 and sucks each liquid of the mixed liquid and the cleaning liquid in the reaction container 2011.

The stirring unit 215 is provided near an outer periphery of the reaction disk 201. The stirring unit 215 includes a stirrer, and the stirrer stirs a mixed liquid of the sample and the first reagent contained in the reaction container 2011 located at a stirring position on the reaction disk 201. Alternatively, the stirring unit 215 stirs a mixed liquid of the sample, the first reagent, and the second reagent contained in the reaction container 2011.

Note that, although not illustrated in FIG. 2, a cleaning tank for cleaning the reagent dispensing probe is provided on each of the rotation trajectory of the first reagent dispensing probe 209 and the rotation trajectory of the second reagent dispensing probe 211. In the cleaning tank, for example, cleaning using a detergent is performed on the reagent dispensing probe.

Next, a function of the control circuit 9 according to the first embodiment will be described. For example, the control circuit 9 has a system control function 91, an acquisition function 92, a setting function 93, and a determination function 94 by executing an operation program. In the first embodiment, a case where the system control function 91, the acquisition function 92, the setting function 93, and the determination function 94 are implemented by a single processor will be described, but the present invention is not limited thereto. For example, a control circuit may be configured by combining a plurality of independent processors, and each processor may execute a control program to implement the system control function 91, the acquisition function 92, the setting function 93, and the determination function 94.

The control circuit 9 integrally controls each unit in the automatic analyzing apparatus 1 based on, for example, input information input from the input interface 5 by the system control function 91. Specifically, the control circuit 9 controls rotation operation of the reaction disk 201, rotation operation and dispensing operation of the sample dispensing probe 207, rotation operation and dispensing operation of the second reagent dispensing probe 211, and the like.

Further, the control circuit 9 executes each function related to the reagent contamination avoidance processing according to the read control program. The above functions include, for example, the acquisition function 92, the setting function 93, the determination function 94, and the like. Note that, each of the above functions may include some functions of the system control function 91.

The control circuit 9 acquires the examination target sample information and the information on one or more examination items associated with the sample by the acquisition function 92. Further, the control circuit 9 may acquire the sample order information. All of these pieces of information are stored in the storage circuit 8.

The control circuit 9 sets a measurement order of a plurality of examination items for the sample to be examined by the setting function 93. Specifically, the control circuit 9 rearranges the measurement order based on the attribute information. In the case of rearranging the measurement order, the control circuit 9 may specify a reagent that includes physical property information in the attribute information and an examination item using this reagent.

The control circuit 9 performs various determinations by the determination function 94. Specifically, the control circuit 9 performs determination regarding reagent contamination, determination as to whether or not there is an examination item using a reagent for which attribute information regarding cleaning is set, determination as to whether or not probe cleaning is necessary, and the like. Probe cleaning herein means detergent cleaning in which the reagent dispensing probe is cleaned with a detergent. Further, in a case where probe cleaning is performed, a cycle for cleaning shall be required.

Next, the operation of the automatic analyzing apparatus 1 according to the first embodiment configured as described above will be described according to a processing procedure of the reagent contamination avoidance processing executed by the control circuit 9.

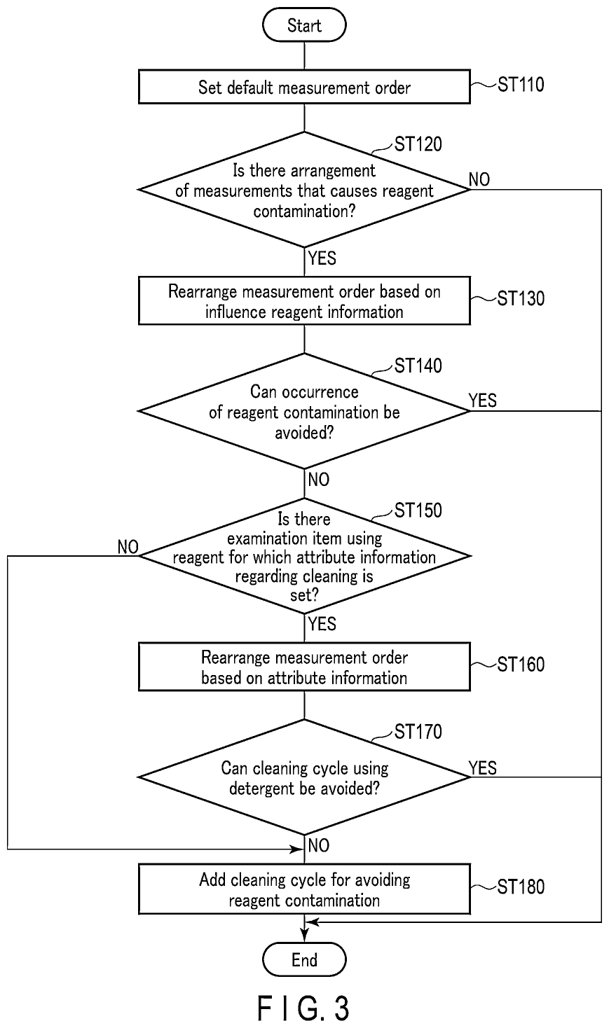

FIG. 3 is a flowchart illustrating an operation example of the reagent contamination avoidance processing in the first embodiment. The flowchart of FIG. 3 starts, for example, after the control circuit 9 acquires the examination target sample information and the sample order information by the acquisition function 92. Note that, in the flowchart of FIG. 3, it is assumed that the measurement order of the plurality of examination items set for one sample among a plurality of samples included in the sample order information is set.

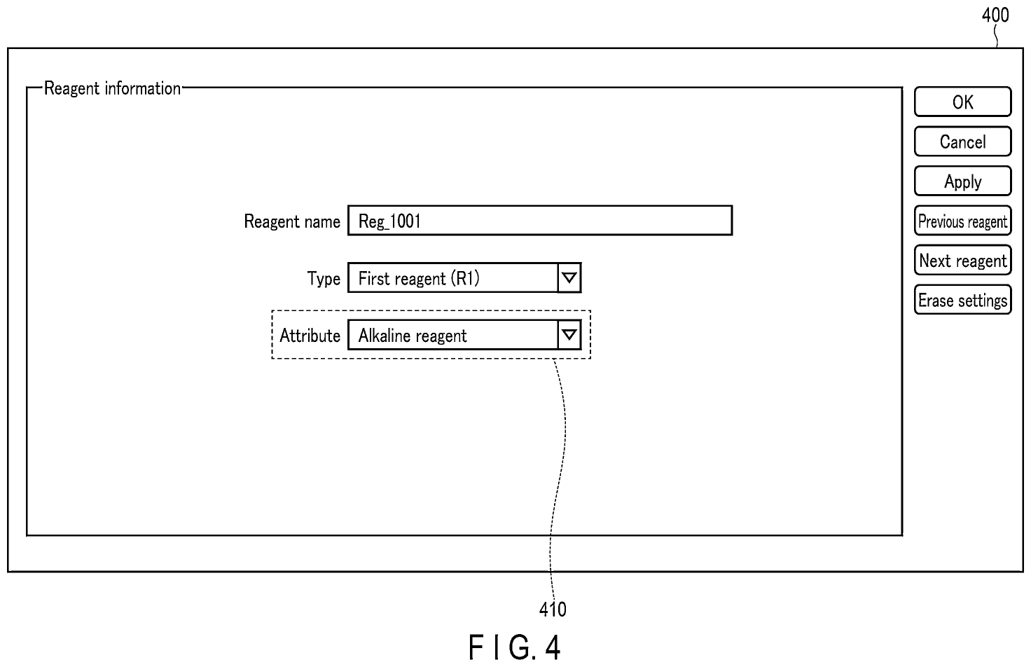

In the flowchart of FIG. 3, as a specific example, it is assumed that the measurement order of three examination items (examination item Ex 0001, examination item Ex 0002, and examination item Ex 0003) set for a certain sample is set. Hereinafter, the reagents related to these examination items and the setting of each examination item will be described with reference to FIGS. 4 to 8.

FIG. 4 is a diagram illustrating a display example of a reagent registration window in the first embodiment. A reagent registration window 400 illustrated in FIG. 4 displays reagent information.

In the example of FIG. 4, as reagent information, the type “first reagent (R1)” and the attribute “alkaline reagent” (attribute information 410) are associated with the reagent name “Reg_1001”.

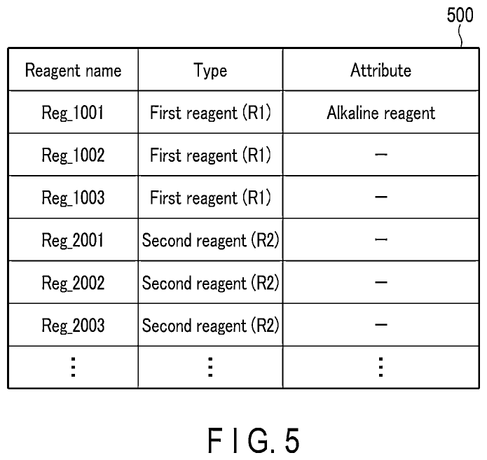

FIG. 5 is a diagram illustrating an example of registered reagent information in the first embodiment. Registered reagent information 500 illustrated in FIG. 5 is information in which the reagent name, type, and attribute of the reagent loaded on the automatic analyzing apparatus 1 are associated with each other.

In the example of FIG. 5, in the registered reagent information 500, the type “first reagent (R1)” and the attribute “alkaline reagent” are associated with the reagent name “Reg_1001”. Further, in the registered reagent information 500, the type “first reagent (R1)” is associated with the reagent names “Reg_1002” and “Reg_1003”, respectively. Furthermore, in the registered reagent information 500, the type “second reagent (R2)” is associated with the reagent names “Reg_2001”, “Reg_2002”, and “Reg_2003”, respectively. In other words, in the example of FIG. 5, the attribute information is set only for the reagent Reg_1001.

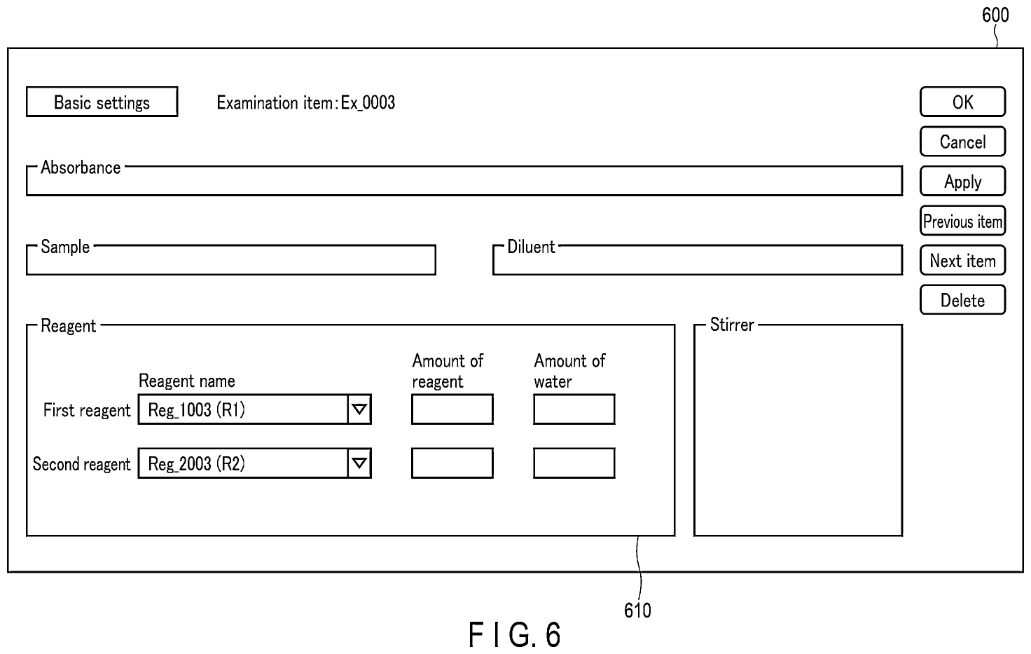

FIG. 6 is a diagram illustrating a display example of an examination item registration window (basic settings) in the first embodiment. An examination item registration window 600 illustrated in FIG. 6 displays basic setting information.

In the example of FIG. 6, as the basic setting information, examination item reagent information 610 is set for the examination item “Ex_0003”. In the examination item reagent information 610, the first reagent “Reg_1003 (R1)” and the second reagent “Reg_2003 (R2)” are associated with each other.

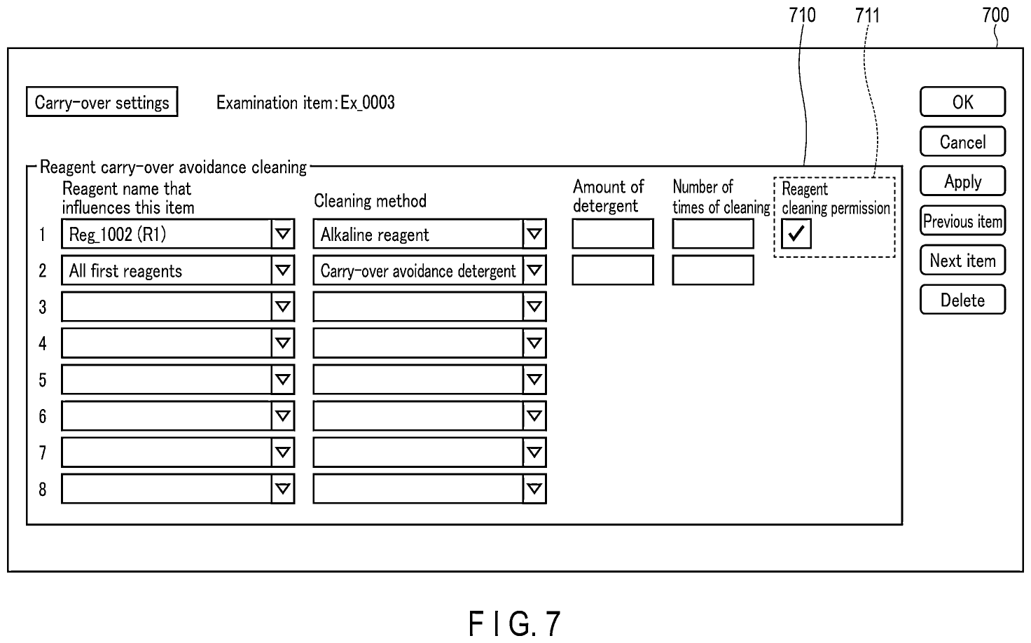

FIG. 7 is a diagram illustrating a display example of an examination item registration window (carry-over settings) in the first embodiment. The examination item registration window illustrated in FIG. 7 displays carry-over setting information.

In the example of FIG. 7, as the carry-over setting information, reagent carry-over avoidance cleaning information 710 is set for the examination item “Ex_0003”. In the reagent carry-over avoidance cleaning information 710, the influence reagent name “Reg_1002 (R1)”, the cleaning method “alkaline reagent”, and the reagent cleaning permission “checked” (reagent cleaning permission information 711) are associated with each other as a first setting, and the influence reagent name “all first reagents” and the cleaning method “carry-over avoidance detergent” are associated with each other as a second setting. Note that, “all first reagents” means “all of the first reagents”. In other words, the examination item for which the influence reagent name “all first reagents” is set requires either detergent cleaning or cleaning similar thereto after the examination of the immediately preceding examination item.

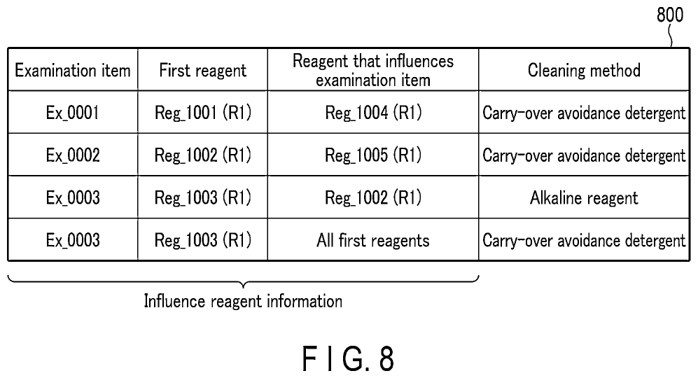

FIG. 8 is a diagram illustrating an example of registered examination item information in the first embodiment. Registered examination item information 800 illustrated in FIG. 8 is information in which the first reagent set for the examination item, the reagent that influences the examination item (influence reagent), and the cleaning method for avoiding an influence of reagent carry-over are associated with the examination item registered in the automatic analyzing apparatus 1. Note that, a combination of the examination item, the first reagent, and the reagent that influences the examination item may be referred to as influence reagent information.

In the example of FIG. 8, in the registered examination item information 800, the first reagent “Reg_1001 (R1)”, the influence reagent “Reg_1004 (R1)”, and the cleaning method “carry-over avoidance detergent” are associated with the examination item “Ex_0001”. Further, in the registered examination item information 800, the first reagent “Reg_1002 (R1)”, the influence reagent “Reg_1005 (R1)”, and the cleaning method “carry-over avoidance detergent” are associated with the examination item “Ex_0002”. Further, in the registered examination item information 800, the first reagent “Reg_1003 (R1)”, the influence reagent “Reg_1002 (R1)”, and the cleaning method “alkaline reagent” are associated with the examination item “Ex_0003”. Furthermore, in the registered examination item information 800, the first reagent “Reg_1003 (R1)”, the influence reagent “all first reagents”, and the cleaning method “carry-over avoidance detergent” are associated with the examination item “Ex_0003”.

### (Step ST110)

When the reagent contamination avoidance processing is started, the control circuit 9 sets a default measurement order by the setting function 93. The default measurement order is, for example, the order of the examination items registered in an examination request. Further, in the first embodiment, it is assumed that reagent contamination is not considered in the default measurement order.

In a specific example, the default measurement order is the order of the examination item “Ex_0001”, the examination item “Ex_0002”, and the examination item “Ex_0003”.

### (Step ST120)

After setting the default measurement order, the control circuit 9 determines, by the determination function 94, whether or not there is an arrangement of measurements that causes reagent contamination. Specifically, the control circuit 9 makes a determination based on the basic setting information and the carry-over setting information set for each of the plurality of examination items. In a case where it is determined that there is an arrangement of measurements that causes reagent contamination, the processing proceeds to step ST130. In a case where it is determined that there is no arrangement of measurements that causes reagent contamination, the processing ends.

In a specific example, since the arrangement of the examination item “Ex_0002” and the examination item “Ex_0003” is the arrangement of measurements that causes reagent contamination, the control circuit 9 determines that there is an arrangement of measurements that causes reagent contamination.

### (Step ST130)

After it is determined that there is an arrangement of measurements that causes reagent contamination, the control circuit 9 rearranges the measurement order based on the influence reagent information by the setting function 93. The influence reagent information is, for example, information in which the examination item, the first reagent, and the reagent that influences the examination item are associated with each other. Note that, in step ST130, rearrangement is not necessarily performed. For example, in a case where “all first reagents” are included in the reagent that influences the examination item, there is a possibility that the influence of reagent contamination cannot be eliminated even if rearrangement is performed.

In a specific example, since the influence reagent “all first reagents” is associated with the examination item “Ex_0003”, the control circuit 9 does not perform rearrangement from the default measurement order. Note that, the control circuit 9 cannot set the examination item “Ex_0003” to the beginning (first) in the measurement order due to the influence of the examination item in the immediately preceding sample.

### (Step ST140)

After the processing of step ST130, the control circuit 9 determines whether or not occurrence of reagent contamination can be avoided by the determination function 94. The determination here is similar to the determination in step ST120. In a case where it is determined that the occurrence of reagent contamination cannot be avoided, the processing proceeds to step ST150. In a case where it is determined that the occurrence of reagent contamination can be avoided, the processing ends.

In a specific example, since rearrangement has not been performed in step ST130, the control circuit 9 determines that the occurrence of reagent contamination cannot be avoided in the current measurement order (which is the same as the default measurement order).

### (Step ST150)

After determining that the occurrence of reagent contamination cannot be avoided, the control circuit 9 determines, by the determination function 94, whether or not there is an examination item using a reagent for which attribute information regarding cleaning is set. Specifically, the control circuit 9 makes a determination based on the influence reagent information and the registered reagent information. The registered examination item information is information in which the cleaning method is further associated with the influence reagent information described above. The registered reagent information is information in which the reagent name, type, and attributes of the reagent loaded in the automatic analyzing apparatus 1 are associated with each other. In a case where it is determined that there is an examination item using a reagent for which attribute information regarding cleaning is set, the processing proceeds to step ST160. In a case where it is determined that there is no examination item using a reagent for which attribute information regarding cleaning is set, the processing proceeds to step ST180. Note that, the registered examination item information may be used instead of the influence reagent information.

In a specific example, since the attribute “alkaline reagent” is associated with the reagent name “Reg_1001” of the registered reagent information, and the first reagent “Reg_1001 (R1)” is associated with the examination item “Ex_0001” of the influence reagent information, the control circuit 9 determines that there is an examination item using a reagent for which attribute information regarding cleaning is set.

In other words, the control circuit 9 determines whether or not there is a first examination item (for example, the examination item “Ex_0001”) using the first reagent (for example, the reagent name “Reg_1001”) in which the attribute information (for example, the attribute “alkaline reagent” that is physical property information) is set for the plurality of examination items.

### (Step ST160)

After determining that there is an examination item using a reagent for which attribute information regarding cleaning is set, the control circuit 9 rearranges the measurement order based on the attribute information by the setting function 93. Specifically, the control circuit 9 rearranges the measurement order based on the registered examination item information in which the attribute information is included in the item of the cleaning method and the registered reagent information in which the attribute information is included. Note that, in step ST160, rearrangement is not necessarily performed.

In a specific example, since the examination item “Ex_0003”, the first reagent “Reg_1003 (R1)”, the influence reagent “Reg_1002 (R1)”, and the cleaning method “alkaline reagent” are associated with each other in the registered examination item information, and the reagent name “Reg_1001” and the attribute “alkaline reagent” are associated with each other in the registered reagent information, the control circuit 9 sets the examination item “Ex_0002” with the influence reagent “Reg_1002 (R1)” as the first reagent at the beginning of the measurement order, then sets the examination item “Ex_0001” with the reagent name “Reg_1001” for which the cleaning method “alkaline reagent” is the attribute as the first reagent, and finally sets the examination item “Ex_0003”. As a result, the control circuit 9 rearranges the default measurement order in the order of the examination item “Ex_0002”, the examination item “Ex_0001”, and the examination item “Ex_0003”.

In other words, in a case where the plurality of examination items includes the first examination item, the control circuit 9 rearranges the measurement order based on the attribute information.

### (Step ST170)

After the processing of step ST160, the control circuit 9 determines whether or not a cleaning cycle using a detergent can be avoided by the determination function 94. The determination here is similar to the determination in step ST120. The reason why the determination is similar to the determination in step ST120 is that in a case where there is an arrangement order in which reagent contamination occurs, cleaning using a detergent is required to avoid the occurrence of reagent contamination. In a case where it is determined that a cleaning cycle using a detergent cannot be avoided, the processing proceeds to step ST180. In a case where it is determined that a cleaning cycle using a detergent can be avoided, the processing ends.

In a specific example, if the measurement order is the order of the examination item “Ex_0002”, the examination item “Ex_0001”, and the examination item “Ex_0003”, the examination item “Ex_0001” using the reagent “Reg_1001” that can be expected to have the same effect as detergent cleaning is performed after the examination item “Ex_0002” using the reagent “Reg_1002” that influences the examination item “Ex_0003”, and thus the control circuit 9 determines that a cleaning cycle using a detergent can be avoided.

On the other hand, if the default measurement order is used, since detergent cleaning is required after the examination item “Ex_0002” using the reagent “Reg_1002” that influences the examination item “Ex_0003”, the control circuit 9 determines that a cleaning cycle using a detergent cannot be avoided.

In other words, since the measurement order is rearranged based on the attribute information in step ST160, in a case where the first examination item is included in the plurality of examination items, the control circuit 9 determines the necessity of probe cleaning based on the attribute information.

### (Step ST180)

After it is determined in step ST150 that there is no examination item using a reagent for which attribute information regarding cleaning is set, or after it is determined in step ST170 that a cleaning cycle using a detergent cannot be avoided, the control circuit 9 adds a cleaning cycle using a detergent for avoiding reagent contamination. After step ST180, the reagent contamination avoidance processing ends.

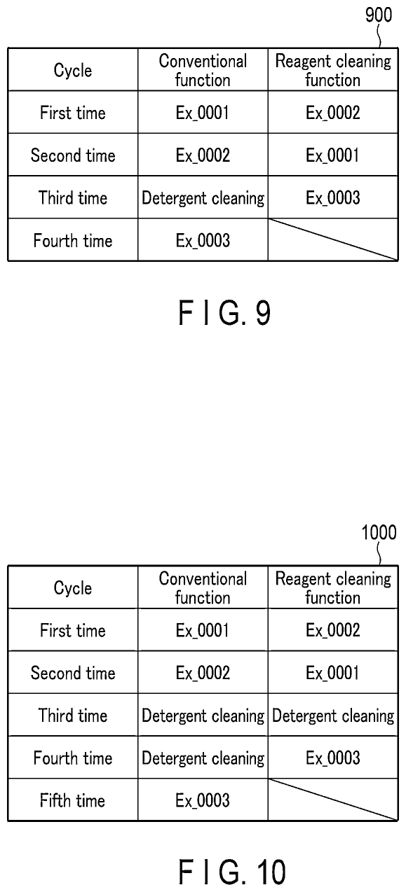

FIG. 9 is a diagram illustrating an execution result of the reagent contamination avoidance processing in the first embodiment. An execution result 900 illustrated in FIG. 9 includes, for reference, a measurement order using a conventional reagent contamination avoidance function (conventional function) and a measurement order using a function of performing cleaning with a reagent instead of detergent cleaning in the first embodiment (reagent cleaning function).

In the execution result 900, the measurement of the conventional function is performed in the order of the examination item “Ex_0001”, the examination item “Ex_0002”, detergent cleaning, and the examination item “Ex_0003”, and requires four cycles. On the other hand, the measurement of the reagent cleaning function is performed in the order of the examination item “Ex_0002”, the examination item “Ex_0001”, and the examination item “Ex_0003”, and requires only three cycles.

A difference between the result of the reagent cleaning function and the result of the conventional function is whether or not attribute information is included in the reagent information. In the conventional function, since attribute information is not included in the reagent information, a means for avoiding reagent carry-over is limited to normal rearrangement or detergent cleaning. In the normal rearrangement, there is a case where rearrangement cannot be performed or reagent carry-over cannot be avoided even if rearrangement can be performed due to the influence of the examination item in the immediately preceding sample. In such a case, it is necessary to perform detergent cleaning immediately before the examination item in which reagent carry-over may occur, and a cleaning cycle using a detergent occurs. On the other hand, in the reagent cleaning function, since attribute information is included in the reagent information, in a case where there is a reagent instead of detergent cleaning, detergent cleaning can be replaced with an examination of the examination item using this reagent, and a cleaning cycle using a detergent can be prevented from occurring.

Detailed specific examples of the reagent cleaning function in the first embodiment will be described below. For example, it is assumed that a plurality of examination items is set for a certain sample for which an examination request has been made, and the plurality of set examination items includes a first examination item, a second examination item, and a third examination item. Further, it is assumed that the first examination item uses a first reagent for which attribute information (physical property information) is set. Further, it is assumed that the measurement order before rearrangement (default measurement order) is the order of the first examination item, the second examination item, and the third examination item.

In a first specific example, in a case where the third examination item is influenced by reagent contamination from the second reagent used in the second examination item, and in a case where the third examination item is permitted to be cleaned with a reagent for which physical property information is set as a method for avoiding the influence of reagent contamination, the automatic analyzing apparatus 1 specifies a first reagent, which is a reagent for which physical property information is set, and a first examination item that uses the first reagent, and rearranges the default measurement order in the order of the second examination item, the first examination item, and the third examination item.

In a second specific example, in a case where the third examination item is influenced by reagent contamination from all reagents used in other examination items, and in a case where the third examination item is permitted to be cleaned with a reagent for which physical property information is set as a method for avoiding the influence of reagent contamination, the automatic analyzing apparatus 1 specifies a first reagent, which is a reagent for which physical property information is set, and a first examination item that uses the first reagent, and rearranges the default measurement order in the order of the second examination item, the first examination item, and the third examination item.

In a third specific example, in a case where the third examination item is influenced by reagent contamination from all reagents used in other examination items, and in a case where the third examination item is permitted to be cleaned with a reagent for which physical property information is set as a method for avoiding the influence of reagent contamination of the second reagent used in the second examination item, the automatic analyzing apparatus 1 specifies a first reagent, which is a reagent for which physical property information is set, and a first examination item that uses the first reagent, and rearranges the default measurement order in the order of the second examination item, the first examination item, and the third examination item.

As described above, the automatic analyzing apparatus according to the first embodiment stores the attribute information indicating the attribute regarding cleaning set for any one of a plurality of reagents, and executes at least one of rearrangement of the measurement order of the plurality of examination items in the examination and determination of the necessity of probe cleaning with a detergent in the examination based on the attribute information. Further, the attribute information in the first embodiment includes physical property information indicating physical properties related to hydrogen ions contained in the reagent.

Therefore, the automatic analyzing apparatus according to the first embodiment executes at least one of rearrangement of the examination items based on the attribute information and determination of the necessity of detergent cleaning based on the attribute information, thereby replacing detergent cleaning with reagent cleaning, so that the throughput of the examination can be improved.

### Modification of First Embodiment

In the first embodiment, a case where detergent cleaning requiring one cycle is performed has been described. On the other hand, in a modification of the first embodiment, a case where detergent cleaning requiring a plurality of cycles is performed will be described.

In a case where detergent cleaning requiring a plurality of cycles is replaced with an examination of an examination item using a reagent that has a cleaning effect, the control circuit 9 may replace with the examination of an examination item using a reagent that has a cleaning effect for any cycle among a plurality of cycles for performing detergent cleaning. For example, replacement in a case where detergent cleaning requiring two cycles is performed will be described with reference to FIG. 10.

FIG. 10 is a diagram illustrating an execution result of the reagent contamination avoidance processing in the modification of the first embodiment. An execution result 1000 illustrated in FIG. 10 includes, for reference, a measurement order using the conventional function and a measurement order using the reagent cleaning function.

In the execution result 1000, the measurement of the conventional function is performed in the order of the examination item “Ex_0001”, the examination item “Ex_0002”, detergent cleaning, detergent cleaning, and the examination item “Ex_0003”, and requires five cycles. On the other hand, the measurement of the reagent cleaning function is performed in the order of the examination item “Ex_0002”, the examination item “Ex_0001”, detergent cleaning, and the examination item “Ex_0003”, and requires four cycles. As described above, in the execution result 1000, one cycle of detergent cleaning, which conventionally requires two cycles, is replaced with the examination of the examination item “Ex_0001”.

Therefore, the automatic analyzing apparatus according to the modification of the first embodiment can improve the throughput of the examination by replacing with the examination of an examination item using a reagent that has a cleaning effect for any cycle among a plurality of cycles in which detergent cleaning is required.

Note that, the automatic analyzing apparatus according to the modification of the first embodiment may set a condition that detergent cleaning is always performed in an arbitrary number of cycles among the plurality of cycles in which detergent cleaning is required. Further, in a case where detergent cleaning requiring a plurality of cycles is performed, the automatic analyzing apparatus according to the modification of the first embodiment may prohibit replacement with the examination of an examination item using a reagent that has a cleaning effect.

### Second Embodiment

In the first embodiment, a specific example of attribute information has been described as physical property information. On the other hand, in the second embodiment, a specific example of attribute information will be described as a specific examination item (specific item). Note that, the configuration of an automatic analyzing apparatus according to the second embodiment is similar to the automatic analyzing apparatus 1 illustrated in FIG. 1 and the analysis mechanism 2 illustrated in FIG. 2. Hereinafter, a configuration specific to the second embodiment will be described.

In the second embodiment, reagent information stored in a storage circuit 8 includes, for example, information such as a reagent name, a type, an attribute, and a specific item (reagent), which are associated with each other. The information on the attribute (attribute information) in the second embodiment is cleaning information indicating a cleaning effect on a specific examination item or a specific reagent. The attribute information includes a specific item cleaning reagent. The information on the specific item (specific item information) includes information on an examination item. Note that, the specific item information may be information on a reagent used in the examination item. Hereinafter, the “specific item information” includes at least one of “information on an examination item” and “information on a reagent used in the examination item”.

In the second embodiment, a control circuit 9 performs determination as to whether or not there is an examination item using a reagent for which attribute information regarding cleaning is set, determination regarding reagent contamination, and determination as to whether or not probe cleaning is necessary, and the like, by a determination function 94.

Next, the operation of an automatic analyzing apparatus 1 according to the second embodiment configured as described above will be described according to the processing procedure of the reagent contamination avoidance processing executed by the control circuit 9.

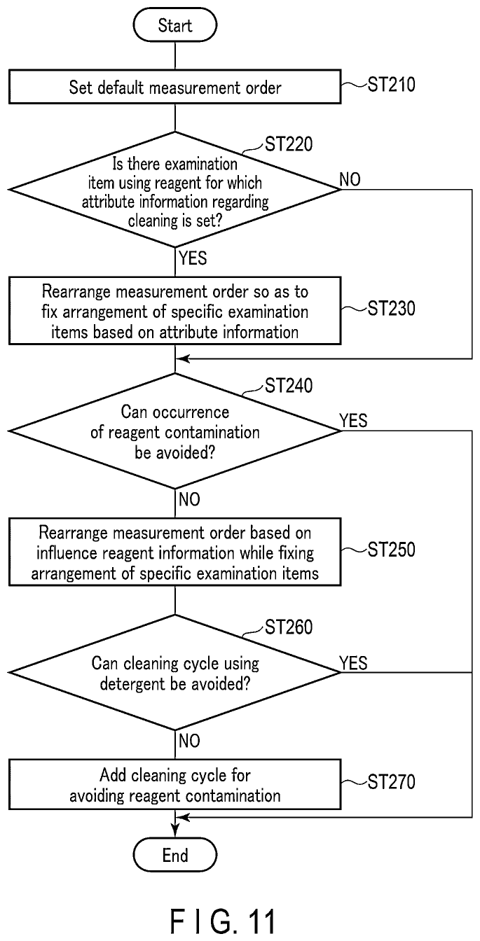

FIG. 11 is a flowchart illustrating an operation example of the reagent contamination avoidance processing in the second embodiment. The flowchart of FIG. 11 starts, for example, after the control circuit 9 acquires the examination target sample information and the sample order information by an acquisition function 92. Note that, in the flowchart of FIG. 11, it is assumed that the measurement order of the plurality of examination items set for one sample among a plurality of samples included in the sample order information is set.

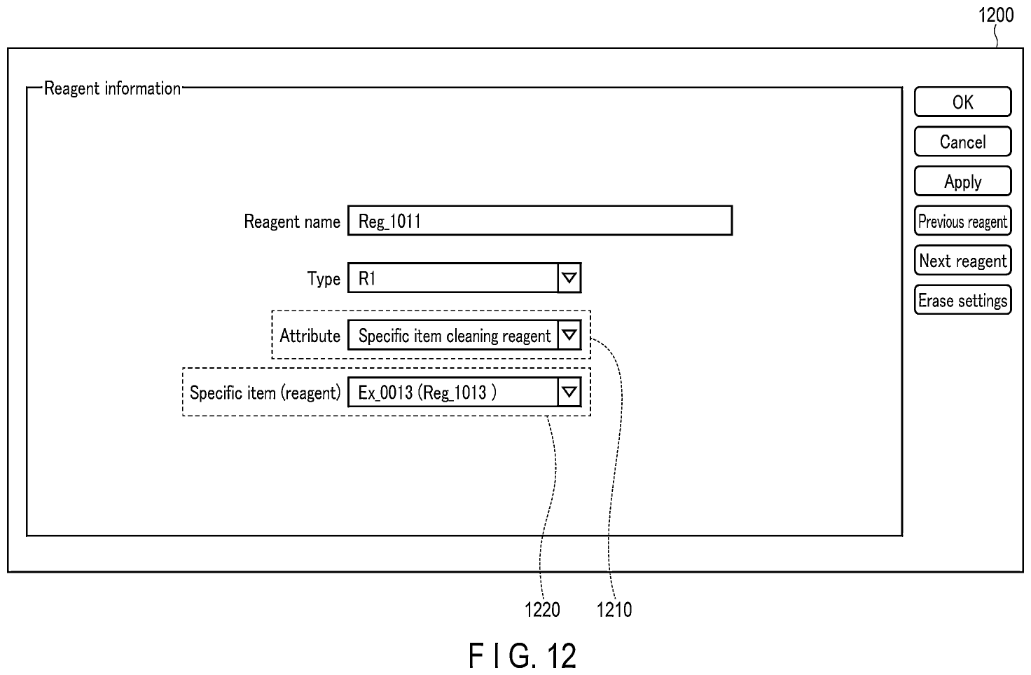

In the flowchart of FIG. 11, as a specific example, it is assumed that the measurement order of three examination items (examination item Ex_0011, examination item Ex_0012, and examination item Ex_0013) set for a certain sample is set. Hereinafter, the reagents related to these examination items and the settings of each examination item will be described with reference to FIGS. 12 to 16.

FIG. 12 is a diagram illustrating a display example of a reagent registration window in the second embodiment. A reagent registration window 1200 illustrated in FIG. 12 displays reagent information.

In the example of FIG. 12, as reagent information, the type “first reagent (R1)”, the attribute “specific item cleaning reagent” (attribute information 1210), and the specific item (reagent) “Ex_0013 (Reg_1013)” (specific item information 1220) are associated with the reagent name “Reg_1011”.

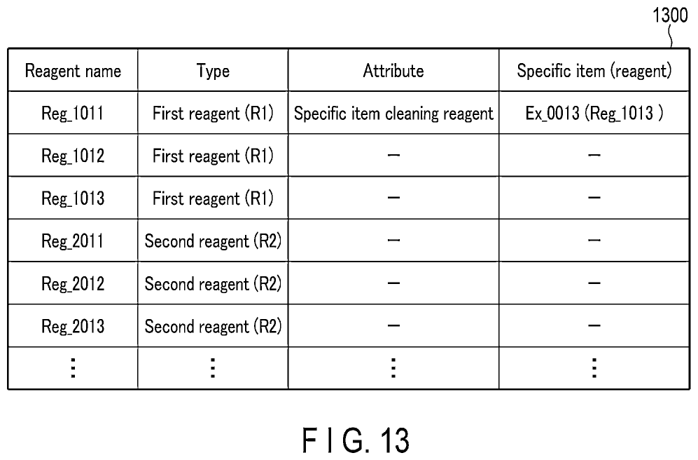

FIG. 13 is a diagram illustrating an example of registered reagent information in the second embodiment. Registered reagent information 1300 illustrated in FIG. 13 is information in which the reagent name, type, attribute, and specific item (reagent) of the reagent loaded on the automatic analyzing apparatus 1 are associated with each other.

In the example of FIG. 13, in the registered reagent information 1300, the type “first reagent (R1)”, the attribute “specific item cleaning reagent”, and the specific item (reagent) “Ex_0013 (Reg_1013)” are associated with the reagent name “Reg_1011”. Further, in the registered reagent information 1300, the type “first reagent (R1)” is associated with the reagent names “Reg_1012” and “Reg_1013”, respectively. Furthermore, in the registered reagent information 1300, the type “second reagent (R2)” is associated with the reagent names “Reg_2011”, “Reg_2012”, and “Reg_2013”, respectively. In other words, in the example of FIG. 13, the attribute information and specific item information are set only for the reagent Reg_1011.

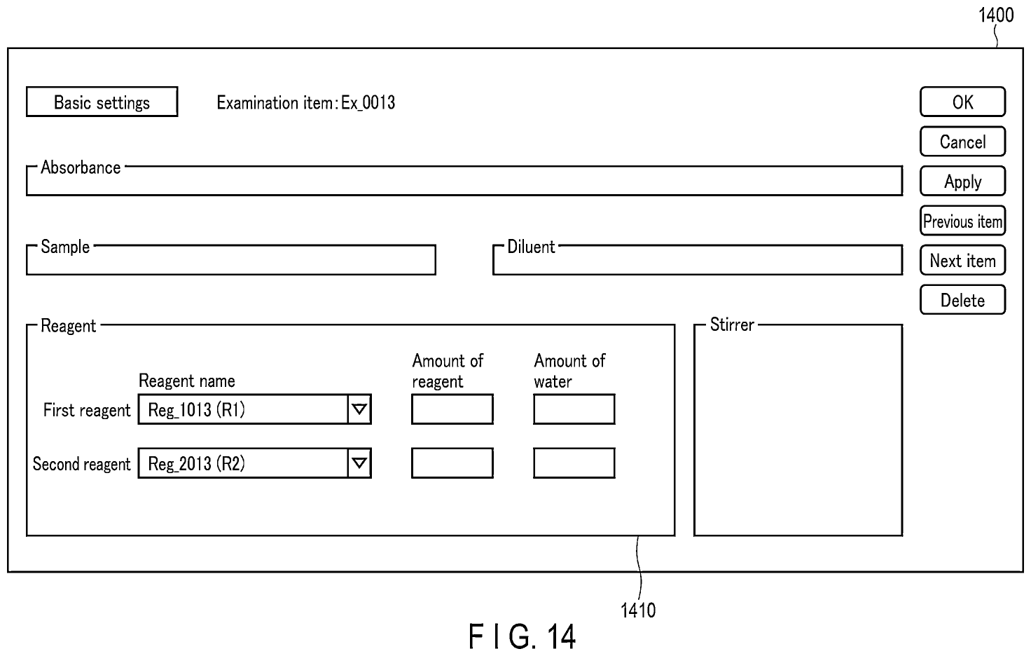

FIG. 14 is a diagram illustrating a display example of an examination item registration window (basic settings) in the second embodiment. An examination item registration window 1400 displayed in FIG. 14 displays basic setting information.

In the example of FIG. 14, as the basic setting information, examination item reagent information 1410 is set for the examination item “Ex_0013”. The first reagent “Reg_1013 (R1)” and the second reagent “Reg_2013 (R2)” are associated with each other in the examination item reagent information 1410.

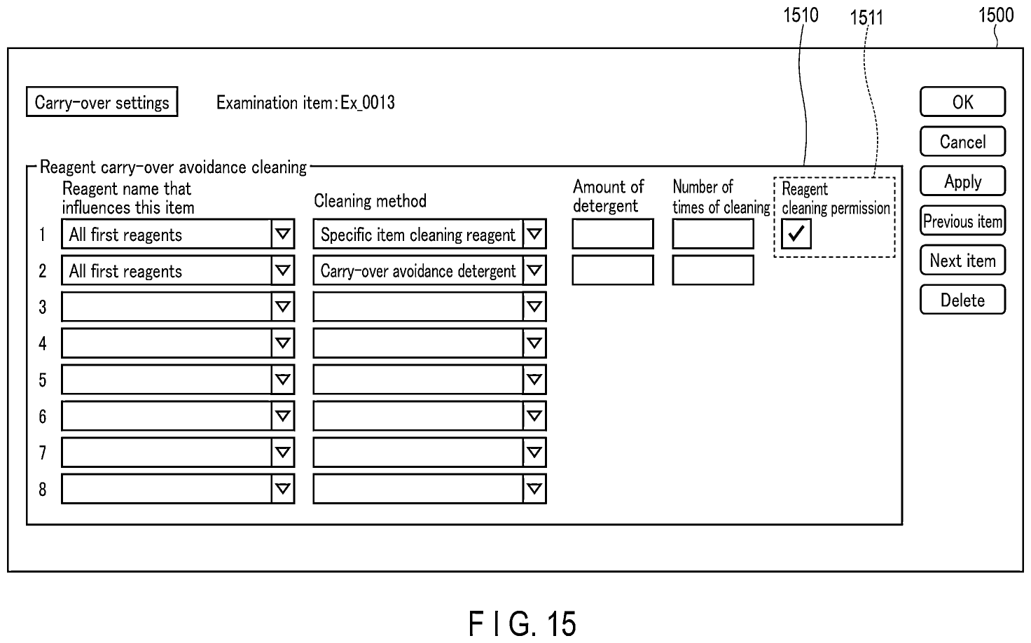

FIG. 15 is a diagram illustrating a display example of an examination item registration window (carry-over settings) in the second embodiment. The examination item registration window illustrated in FIG. 15 displays carry-over setting information.

In the example of FIG. 15, as the carry-over setting information, reagent carry-over avoidance cleaning information 1510 is set for the examination item “Ex_0013”. In the reagent carry-over avoidance cleaning information 1510, the influence reagent name “all first reagents”, the cleaning method “specific item cleaning reagent”, and the reagent cleaning permission “checked” (reagent cleaning permission information 1511) are associated with each other as a first setting, and the influence reagent name “all first reagents” and the cleaning method “carry-over avoidance detergent” are associated with each other as a second setting.

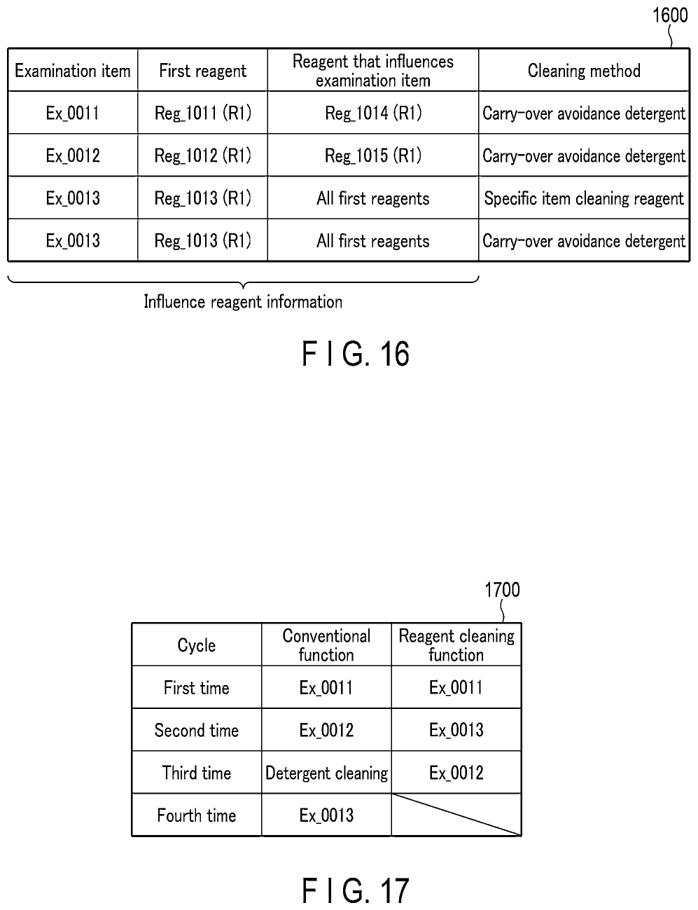

FIG. 16 is a diagram illustrating an example of registered examination item information in the second embodiment. Registered examination item information 1600 illustrated in FIG. 16 is information in which the first reagent set for the examination item, the influence reagent, and the cleaning method are associated with the examination item registered in the automatic analyzing apparatus 1.

In the example of FIG. 16, in the registered examination item information 1600, the first reagent “Reg_1011 (R1)”, the influence reagent “Reg_1014 (R1)”, and the cleaning method “carry-over avoidance detergent” are associated with the examination item “Ex_0011”. Further, in the registered examination item information 1600, the first reagent “Reg_1012 (R1)”, the influence reagent “Reg_1015 (R1)”, and the cleaning method “carry-over avoidance detergent” are associated with the examination item “Ex_0012”. Further, in the registered examination item information 1600, the first reagent “Reg_1013 (R1)”, the influence reagent “all first reagents”, and the cleaning method “specific item cleaning reagent” are associated with the examination item “Ex_0013”. Furthermore, in the registered examination item information 1600, the first reagent “Reg_1013 (R1)”, the influence reagent “all first reagents”, and the cleaning method “carry-over avoidance detergent” are associated with the examination item “Ex_0013”.

### (Step ST210)

When the reagent contamination avoidance processing is started, the control circuit 9 sets a default measurement order by the setting function 93. In the second embodiment, it is assumed that reagent contamination is not considered in the default measurement order.

In a specific example, the default measurement order is the order of the examination item “Ex_0011”, the examination item “Ex_0012”, and the examination item “Ex_0013”.

### (Step ST220)

After setting the default measurement order, the control circuit 9 determines whether or not there is an examination item using a reagent for which attribute information regarding cleaning is set by a determination function 94. Specifically, the control circuit 9 makes a determination based on the influence reagent information and the registered reagent information. In a case where it is determined that there is an examination item using a reagent for which attribute information regarding cleaning is set, the processing proceeds to step ST230. In a case where it is determined that there is no examination item using a reagent for which attribute information regarding cleaning is set, the processing proceeds to step ST240. Note that, the registered examination item information may be used instead of the influence reagent information.

In a specific example, since the attribute “specific item cleaning reagent” is associated with the reagent name “Reg_1011” of the registered reagent information, and the first reagent “Reg_1011 (R1)” is associated with the examination item “Ex_0011” of the influence reagent information, the control circuit 9 determines that there is an examination item using a reagent for which attribute information regarding cleaning is set.

In other words, the control circuit 9 determines whether or not there is a first examination item (for example, the examination item “Ex 1011”) using the first reagent (for example, the reagent name “Reg_1011”) in which the attribute information (for example, the attribute “specific item cleaning reagent”, which is the specific item information) is set for the plurality of examination items.

### (Step ST230)

After determining that there is an examination item using a reagent for which attribute information regarding cleaning is set, the control circuit 9 rearranges the measurement order so as to fix the arrangement of specific examination items based on the attribute information by the setting function 93.

In a specific example, since the examination item “Ex_0013”, the first reagent “Reg_1013 (R1)”, the influence reagent “all first reagents”, and the cleaning method “specific item cleaning reagent” are associated with each other in the registered examination item information, and the reagent name “Reg_1011”, the attribute “specific item cleaning reagent”, and the specific item (reagent) “Ex_0013 (Reg_1013)” are associated with each other in the registered reagent information, the control circuit 9 fixes the arrangement of the examination items so that the examination item “Ex_0013” is performed immediately after the examination item “Ex_0011” with the reagent name “Reg_1011” as the first reagent. Therefore, the control circuit 9 rearranges the default measurement order in the order of the examination item “Ex_0011”, the examination item “Ex_0013”, and the examination item “Ex_0012”. Note that, the control circuit 9 cannot set the examination item “Ex_0012” to the beginning (first) in the measurement order due to the influence of the examination item in the immediately preceding sample.

In other words, in a case where the plurality of examination items includes the first examination item, the control circuit 9 rearranges the measurement order based on the attribute information.

### (Step ST240)

After the processing of step ST220 or the processing of step ST230, the control circuit 9 determines whether or not the occurrence of reagent contamination can be avoided. The determination here is similar to the determination in step ST120 in FIG. 3. In a case where it is determined that the occurrence of reagent contamination cannot be avoided, the processing proceeds to step ST250. In a case where it is determined that the occurrence of reagent contamination can be avoided, the processing ends.

In a specific example, since the measurement order is rearranged in the order of the examination item “Ex_0011”, the examination item “Ex_0013”, and the examination item “Ex_0012” in step ST230, the control circuit 9 determines that the occurrence of reagent contamination can be avoided.

In other words, since the measurement order is rearranged based on the attribute information in step ST230, in a case where the first examination item is included in the plurality of examination items, the control circuit 9 determines the necessity of probe cleaning based on the attribute information.

### (Step ST250)

After determining that the occurrence of reagent contamination cannot be avoided, the control circuit 9 rearranges the measurement order based on the influence reagent information while fixing the arrangement of specific examination items by the setting function 93. Note that, in step ST250, rearrangement does not necessarily need to be performed, and the arrangement of specific examination items does not necessarily need to be fixed.

### (Step ST260)

After the processing of step ST250, the control circuit 9 determines whether or not a cleaning cycle using a detergent can be avoided by the determination function 94. The determination here is similar to the determination in step ST120. The reason why the determination is similar to the determination in step ST120 is that in a case where there is an arrangement order in which reagent contamination occurs, cleaning using a detergent is required to avoid the occurrence of reagent contamination. In a case where it is determined that a cleaning cycle using a detergent cannot be avoided, the processing proceeds to step ST270. In a case where it is determined that a cleaning cycle using a detergent can be avoided, the processing ends.

For example, if the default measurement order is used, since detergent cleaning is required after every examination item (here, the examination item “Ex_0012”) using the reagent “all first reagents” that influences the examination item “Ex_0013”, the control circuit 9 determines that a cleaning cycle using a detergent cannot be avoided.

### (Step ST270)

After determining that a cleaning cycle using a detergent cannot be avoided, the control circuit 9 adds a cleaning cycle for avoiding reagent contamination. After step ST270, the reagent contamination avoidance processing ends.

FIG. 17 is a diagram illustrating an execution result of the reagent contamination avoidance processing in the second embodiment. An execution result 1700 illustrated in FIG. 17 includes, for reference, a measurement order using a conventional reagent contamination avoidance function (conventional function) and a measurement order using a function of performing cleaning with a reagent instead of detergent cleaning in the second embodiment (reagent cleaning function).

In the execution result 1700, the measurement by the conventional function is performed in the order of the examination item “Ex_0011”, the examination item “Ex_0012”, detergent cleaning, and the examination item “Ex_0013”, and requires four cycles. On the other hand, the measurement by the reagent cleaning function is performed in the order of the examination item “Ex_0011”, the examination item “Ex_0013”, and the examination item “Ex_0012”, and requires only three cycles. Note that, the difference between the result of the reagent cleaning function and the result of the conventional function is the same as the content described in the first embodiment.

Detailed specific examples of the reagent cleaning function in the second embodiment will be described below. For example, it is assumed that a plurality of examination items is set for a certain sample for which an examination request has been made, and the plurality of set examination items includes a first examination item, a second examination item, and a third examination item. Further, it is assumed that the first examination item uses a first reagent in which attribute information (cleaning information) is set. Further, it is assumed that the measurement order before rearrangement (default measurement order) is the order of the first examination item, the second examination item, and the third examination item.

In a first specific example, in a case where the third examination item is influenced by reagent contamination from all reagents used in other examination items, and in a case where the third examination item is permitted to be cleaned with a reagent for which cleaning information is set as a method for avoiding the influence of reagent contamination, the automatic analyzing apparatus 1 specifies a first reagent, which is a reagent for which cleaning information is set, and the third examination item as the specific examination item set for the first reagent, and fixes and rearranges the default measurement order in the order of the first examination item and the third examination item.

In a second specific example, in a case where the third examination item is influenced by reagent contamination from all reagents used in other examination items, and in a case where the third examination item is permitted to be cleaned with a reagent for which cleaning information is set as a method for avoiding the influence of reagent contamination, the automatic analyzing apparatus 1 specifies a first reagent, which is a reagent for which cleaning information is set, a third reagent as the specific examination item set for the first reagent, and the third examination item that uses the third reagent, and fixes and rearranges the default measurement order in the order of the first examination item and the third examination item.

As described above, the automatic analyzing apparatus according to the second embodiment stores the attribute information indicating the attribute regarding cleaning set for any one of a plurality of reagents, and executes at least one of rearrangement of the measurement order of the plurality of examination items in the examination and determination of the necessity of probe cleaning with a detergent in the examination based on the attribute information. Further, the attribute information in the second embodiment includes cleaning information indicating a cleaning effect on a specific examination item or a specific reagent.

Therefore, the automatic analyzing apparatus according to the second embodiment executes at least one of rearrangement of the examination items based on the attribute information and determination of the necessity of detergent cleaning based on the attribute information, thereby replacing detergent cleaning with reagent cleaning, so that the throughput of the examination can be improved.

Note that, similarly to the automatic analyzing apparatus according to the modification of the first embodiment, the automatic analyzing apparatus according to the second embodiment may replace with the examination of an examination item using a reagent that has a cleaning effect for any cycle among a plurality of cycles for performing detergent cleaning.

According to at least one embodiment described above, the throughput of the examination can be improved.

Note that, the term “processor” used in the above description means, for example, a central processing unit (CPU), a graphics processing unit (GPU), or a circuit such as an application specific integrated circuit (ASIC) or a programmable logic device (for example, a simple programmable logic device (SPLD), a complex programmable logic device (CPLD), and a field programmable gate array (FPGA)). In a case where the processor is, for example, a CPU, the processor implements a function by reading and executing a program stored in a storage circuit. On the other hand, in a case where the processor is, for example, an ASIC, the function is directly incorporated as a logic circuit in the circuit of the processor instead of the program being stored in the storage circuit. Note that, each processor of the embodiments is not limited to a case where each processor is configured as a single circuit, and a plurality of independent circuits may be combined and configured as one processor to implement the function. Furthermore, a plurality of components in the drawings may be integrated into one processor to implement the function.

In addition, each function according to the embodiments can also be implemented by installing a program that executes the processing on a computer such as a workstation and developing the program on a memory. At this time, the program capable of causing the computer to execute the method can also be stored and distributed on a storage medium such as a magnetic disk (hard disk or the like), an optical disk (CD-ROM, DVD, or the like), or a semiconductor memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automatic analyzing apparatus comprising:
a memory configured to store attribute information indicating an attribute regarding cleaning set for any of a plurality of reagents, and
a processing circuitry configured to perform at least one of rearrangement of a measurement order of a plurality of examination items in an examination and determination of necessity of probe cleaning by a detergent in the examination based on the attribute information.

2. The automatic analyzing apparatus according to claim 1, wherein the processing circuitry is further configured to:
determine whether or not there is a first examination item using a first reagent for which the attribute information is set in the plurality of examination items; and
in a case where the first examination item is included in the plurality of examination items, perform at least one of rearrangement of the measurement order and determination of necessity of the probe cleaning based on the attribute information.

3. The automatic analyzing apparatus according to claim 2, wherein the attribute information includes physical property information indicating physical properties regarding hydrogen ions contained in a reagent.

4. The automatic analyzing apparatus according to claim 3, wherein the plurality of examination items includes the first examination item, a second examination item, and a third examination item, and the processing circuitry is further configured to: in a case where the third examination item is influenced by reagent contamination from a second reagent used in the second examination item, and in a case where the third examination item is permitted to be cleaned with a reagent for which the physical property information is set as a method for avoiding the influence,
specify the first reagent that is a reagent for which the physical property information is set and the first examination item that uses the first reagent; and
rearrange the measurement order in the order of the second examination item, the first examination item, and the third examination item.

5. The automatic analyzing apparatus according to claim 3, wherein the plurality of examination items includes the first examination item, a second examination item, and a third examination item, and the processing circuitry is further configured to: in a case where the third examination item is influenced by reagent contamination from all reagents used in other examination items, and in a case where the third examination item is permitted to be cleaned with a reagent for which the physical property information is set as a method for avoiding the influence,
specify the first reagent that is a reagent for which the physical property information is set and the first examination item that uses the first reagent; and
rearrange the measurement order in the order of the second examination item, the first examination item, and the third examination item.

6. The automatic analyzing apparatus according to claim 3, wherein the plurality of examination items includes the first examination item, a second examination item, and a third examination item, and the processing circuitry is further configured to: in a case where the third examination item is influenced by reagent contamination from all reagents used in other examination items, and in a case where the third examination item is permitted to be cleaned with a reagent for which the physical property information is set as a method for avoiding the influence of a second reagent used in the second examination item,
specify the first reagent that is a reagent for which the physical property information is set and the first examination item that uses the first reagent; and
rearrange the measurement order in the order of the second examination item, the first examination item, and the third examination item.

7. The automatic analyzing apparatus according to claim 2, wherein the attribute information includes cleaning information indicating a cleaning effect on a specific examination item or a specific reagent.

8. The automatic analyzing apparatus according to claim 7, wherein the plurality of examination items includes the first examination item, a second examination item, and a third examination item, and the processing circuitry is further configured to: in a case where the third examination item is influenced by reagent contamination from all reagents used in other examination items, and in a case where the third examination item is permitted to be cleaned with a reagent for which the cleaning information is set as a method for avoiding the influence,
specify the first reagent that is a reagent for which the cleaning information is set and the third examination item as the specific examination item set for the first reagent; and
fix and rearrange the measurement order in the order of the first examination item and the third examination item.

9. The automatic analyzing apparatus according to claim 7, wherein the plurality of examination items includes the first examination item, a second examination item, and a third examination item, and the processing circuitry is further configured to: in a case where the third examination item is influenced by reagent contamination from all reagents used in other examination items, and in a case where the third examination item is permitted to be cleaned with a reagent for which the cleaning information is set as a method for avoiding the influence,
specify the first reagent that is a reagent for which the cleaning information is set, the third reagent as the specific reagent set for the first reagent, and the third examination item that uses the third reagent; and
fix and rearrange the measurement order in the order of the first examination item and the third examination item.

10. A method comprising:
storing attribute information indicating an attribute regarding cleaning set for any of a plurality of reagents; and
performing at least one of rearrangement of a measurement order of a plurality of examination items in an examination and determination of necessity of probe cleaning by a detergent in the examination based on the attribute information.

11. The method according to claim 10, further comprising:
determine whether or not there is a first examination item using a first reagent for which the attribute information is set in the plurality of examination items; and
in a case where the first examination item is included in the plurality of examination items, perform at least one of rearrangement of the measurement order and determination of necessity of the probe cleaning based on the attribute information.

12. The method according to claim 11, wherein the attribute information includes physical property information indicating physical properties regarding hydrogen ions contained in a reagent.

13. The method according to claim 12, wherein the plurality of examination items includes the first examination item, a second examination item, and a third examination item, and further comprising: in a case where the third examination item is influenced by reagent contamination from a second reagent used in the second examination item, and in a case where the third examination item is permitted to be cleaned with a reagent for which the physical property information is set as a method for avoiding the influence,
specify the first reagent that is a reagent for which the physical property information is set and the first examination item that uses the first reagent; and
rearrange the measurement order in the order of the second examination item, the first examination item, and the third examination item.

14. The method according to claim 12, wherein the plurality of examination items includes the first examination item, a second examination item, and a third examination item, and further comprising: in a case where the third examination item is influenced by reagent contamination from all reagents used in other examination items, and in a case where the third examination item is permitted to be cleaned with a reagent for which the physical property information is set as a method for avoiding the influence,
specify the first reagent that is a reagent for which the physical property information is set and the first examination item that uses the first reagent; and
rearrange the measurement order in the order of the second examination item, the first examination item, and the third examination item.

15. The method according to claim 12, wherein the plurality of examination items includes the first examination item, a second examination item, and a third examination item, and further comprising: in a case where the third examination item is influenced by reagent contamination from all reagents used in other examination items, and in a case where the third examination item is permitted to be cleaned with a reagent for which the physical property information is set as a method for avoiding the influence of a second reagent used in the second examination item,
specify the first reagent that is a reagent for which the physical property information is set and the first examination item that uses the first reagent; and
rearrange the measurement order in the order of the second examination item, the first examination item, and the third examination item.

16. The method according to claim 11, wherein the attribute information includes cleaning information indicating a cleaning effect on a specific examination item or a specific reagent.

17. The method according to claim 16, wherein the plurality of examination items includes the first examination item, a second examination item, and a third examination item, and further comprising: in a case where the third examination item is influenced by reagent contamination from all reagents used in other examination items, and in a case where the third examination item is permitted to be cleaned with a reagent for which the cleaning information is set as a method for avoiding the influence,
specify the first reagent that is a reagent for which the cleaning information is set and the third examination item as the specific examination item set for the first reagent; and
fix and rearrange the measurement order in the order of the first examination item and the third examination item.

18. The method according to claim 16, wherein the plurality of examination items includes the first examination item, a second examination item, and a third examination item, and further comprising: in a case where the third examination item is influenced by reagent contamination from all reagents used in other examination items, and in a case where the third examination item is permitted to be cleaned with a reagent for which the cleaning information is set as a method for avoiding the influence,
specify the first reagent that is a reagent for which the cleaning information is set, the third reagent as the specific reagent set for the first reagent, and the third examination item that uses the third reagent; and
fix and rearrange the measurement order in the order of the first examination item and the third examination item.
